(19) United States
(12) Patent Application Publication
(10) Pub. No.: US 2026/0152001 A1
(43) Pub. Date: Jun. 4, 2026

(54) INKJET PRINTING APPARATUS

(71) Applicant: Genix Corporation, Seongnam-si (KR)

(72) Inventors: Steve PARK, Seongnam-si (KR); Soon Ho HONG, Namyangju-si (KR); Seoung Il KONG, Gwacheon-si (KR)

(21) Appl. No.: 19/348,443

(22) Filed: Oct. 2, 2025

(30) Foreign Application Priority Data
Dec. 2, 2024 (KR) 10-2024-0176791

(51) Int. Cl. B41J 2/165; B41J 2/045; B41J 2/17

(52) U.S. Cl. CPC B41J 2/16505; B41J 2/04571; B41J 2/04581; B41J 2/16579; B41J 2/1721; B41J 2002/16594

(57) ABSTRACT

An inkjet apparatus includes an inkjet print head movable in a designated direction and including a first print head nozzle configured to jet ink droplets and a second print head nozzle configured to jet a moisturizing liquid. The inkjet apparatus may also include a capping unit detachably coupled to the inkjet printing head and including a first cap protecting the first print head nozzle and a second cap protecting the second print head nozzle when the capping unit is coupled to the inkjet print head. The inkjet apparatus may further include a processor operatively connected to the inkjet print head and the capping unit, and configured to cause the inkjet print head to jet the moisturizing liquid on the first cap.

### CROSS-REFERENCE TO RELATED APPLICATION

This application is based on and claims priority under 35 U.S.C. § 119 to Korean Patent Application No. 10-2024-0176791, filed on Dec. 2, 2024, in the Korean Intellectual Property Office, the disclosure of which is incorporated by reference herein in its entirety.

### BACKGROUND

### Technical Field

The disclosure relates to an inkjet printing apparatus capable of preventing print head nozzles in an inkjet print head from drying or clogging.

### Description of Related Technology

An inkjet printing apparatus is an apparatus by which desired images may be printed onto print areas of a print media by jetting printing ink to the print media through an inkjet print head. More particularly, the inkjet printing apparatus may print an image having a certain color on a surface of the print media by jetting ink droplets having fine sizes to a desired position on the print media through a print head nozzle of the inkjet print head.

### SUMMARY

One aspect is an inkjet printing apparatus which jets a moisturizing liquid through an inkjet print head capable of jetting the moisturizing liquid as well as ink droplets to thereby provide an appropriate amount of moisture to the print head nozzles without being necessary to increase the size of the inkjet printing apparatus.

The technical aspects of the present disclosure are not limited to those described herein, and other aspects may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

Another aspect is an inkjet apparatus that includes an inkjet print head movable in a designated direction and including a first print head nozzle configured to jet ink droplets and a second print head nozzle configured to jet a moisturizing liquid, a capping unit detachably coupled to the inkjet printing head and including a first cap protecting the first print head nozzle and a second cap protecting the second print head nozzle when the capping unit is coupled to the inkjet print head, and a processor operatively connected to the inkjet print head and the capping unit, wherein the processor is configured to cause the inkjet print head to jet the moisturizing liquid onto the first cap.

In an example, the processor may be configured to, when the inkjet print head and the accommodating unit are coupled to each other, cause the capping unit to move and become detached from the inkjet print head, when the capping unit is detached from the inkjet print head, cause the inkjet print head to move such that the second print head nozzle is arranged at a position corresponding to a position of the first cap, and cause the inkjet print head to jet the moisturizing liquid onto the first cap through the second print head nozzle.

The processor may be further configured to, after the moisturizing liquid is jetted onto the first cap through the second print head nozzle, cause the inkjet print head to move such that the first print head nozzle is arranged at a position corresponding to the position of the first cap, and cause the capping unit to move in a direction toward the inkjet print head and become coupled again to the inkjet print head.

The processor may be further configured to, after a preset time period from a time point at which the cap accommodating and the inkjet print head are coupled to each other, cause the capping unit to move to become detached again from the inkjet print head.

The processor may be further configured to, when a user input is received after the capping unit and the inkjet print head are coupled to each other, cause the capping unit to move to become detached again from the inkjet print head.

In another example, the inkjet printing apparatus may further include an ink waste storage tank in which an ink waste is stored; an ink discard path connecting the capping unit to the ink waste storage tank; and a pump located in the ink discard path and configured to provide power to the ink waste remaining in the first cap to move in a direction toward the ink waste storage tank.

In an example, the processor may be further configured to, when the capping unit is detached from the inkjet print head, provide electrical power to the pump and to discharge the ink waste to the ink waste storage tank.

In another example, the processor may be further configured to adjust an amount of jet of the moisturizing liquid jetted through the second print head nozzle.

The inkjet print head may further include a first piezoelectric element configured to discharge the ink droplets outside the inkjet print head through the first print head nozzle, a second piezoelectric element configured to discharge the moisturizing liquid outside the inkjet print head through the second print head nozzle, and a sensor configured to detect a temperature of the moisturizing liquid.

The processor may be further configured to adjust an electrical signal strength applied to the second piezoelectric element based on the temperature of the moisturizing liquid detected through the sensor such that a constant amount of the moisturizing liquid is jetted onto the first cap.

The inkjet printing apparatus may further include a memory storing data regarding a correlation between the temperature of the moisturizing liquid and viscosity of the moisturizing liquid, and the processor may be further configured to adjust an electrical signal strength applied to the second piezoelectric element, based on the data stored in the memory, wherein the data is about the correlation between the temperature of the moisturizing liquid and the viscosity of the moisturizing liquid.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a perspective view illustrating an inkjet printing apparatus according to an embodiment.

FIG. 2 is a cross-sectional view of the inkjet printing apparatus illustrated in FIG. 1.

FIG. 3 is a block diagram illustrating components of an inkjet printing apparatus according to an embodiment.

FIG. 4 is a flowchart for describing operations to moisturize print head nozzles of an inkjet printing apparatus according to an embodiment.

FIG. 5 is a diagram for describing a process of detaching a capping unit from an inkjet print head in an inkjet printing apparatus according to an embodiment.

FIG. 6 is a diagram for describing a process of jetting moisturizing liquid to a first cap after moving the inkjet print head of the inkjet printing apparatus in FIG. 5.

FIG. 7 is a diagram for describing a process of jetting moisturizing liquid to another first cap after moving the inkjet print head of the inkjet printing apparatus in FIG. 6.

FIG. 8 is a diagram for describing a process of coupling a capping unit to the inkjet print head after moving the inkjet print head of the inkjet printing apparatus in FIG. 7.

FIG. 9 is a diagram for describing a process of discharging residue in a first cap after detaching the capping unit of the inkjet apparatus in FIG. 8 from the inkjet print head.

FIG. 10 is a cross-sectional view of an inkjet printing apparatus according to another embodiment.

FIG. 11 is a graph for describing changes in electrical signals applied to piezoelectric elements in the inkjet printing apparatus in FIG. 10.

### DETAILED DESCRIPTION

In an operation process of the inkjet printing apparatus, some of the ink droplets may be solidified around the print head nozzle, and when the solidified ink droplets block the print head nozzle, printing performance of the inkjet printing apparatus may be degraded. Accordingly, various methods have been studied to prevent degradation of the printing performance of the inkjet printing apparatus due to the solidified ink droplets.

As a solution to prevent drying or clogging of print head nozzles, an inkjet printing apparatus including an additional reservoir accommodating a moisturizing liquid and an additional moisturizing liquid-jetting apparatus has been suggested. However, in such a case where other components are added, the entire size of the inkjet printing apparatus increases.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Regarding terms used in embodiments, general terms currently and wisely used are selected in consideration of functions in the disclosure. However, meanings of the terms may be changed according to intentions of one of ordinary skill in the art, judicial precedence, appearance of a new technology, and the like. In addition, in certain cases, terms may be arbitrarily selected by the applicant in particular cases. In such a case, the meaning of the terms will be described in detail at the corresponding portion in the description of the disclosure. Therefore, the terms used in the disclosure should be defined based on the meanings of the terms and the descriptions throughout the disclosure.

In the disclosure, expression that a portion “includes” components or operations should not be interpreted as including all components or operations, but should be interpreted that the portion may not include some of the components or operations or further include additional components and operations. The terms “-er”, “-or”, and “module” described in the disclosure indicate units for processing at least one function and operation, and may be implemented by hardware components or software components and combinations thereof.

As used herein, an expression such as “at least only one” precedes arranged elements, it modifies all elements rather than each arranged elements. For example, the expression “at least any one of a, b, and c” should be construed to include a, b, c, or a and b, a and c, b and c, or a, b, and c.

In the disclosure, “inkjet printing apparatus” may indicate an apparatus by which an image may be printed onto a print media by discharging fine-sized ink droplets on a desired position of the print media.

Hereinafter, embodiments will be described in detail with reference to the accompanying drawings such that the embodiments may be easily practiced by one of ordinary skill in the art. The embodiments may be implemented in various forms and are not limited to those described herein.

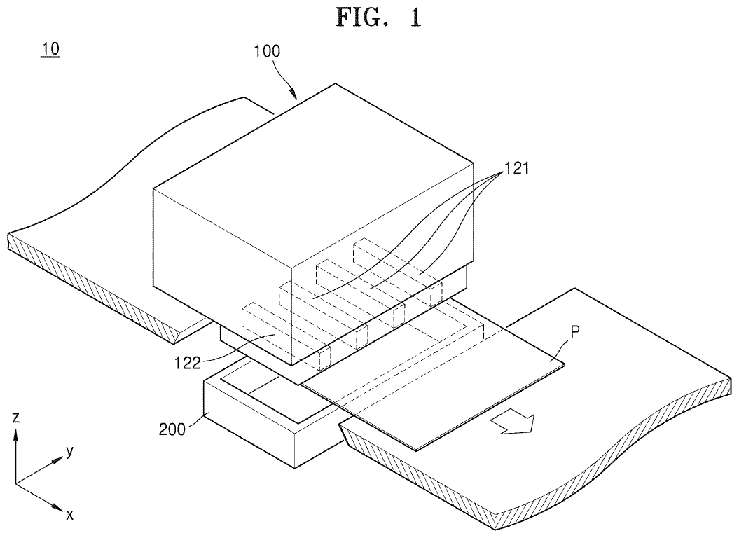

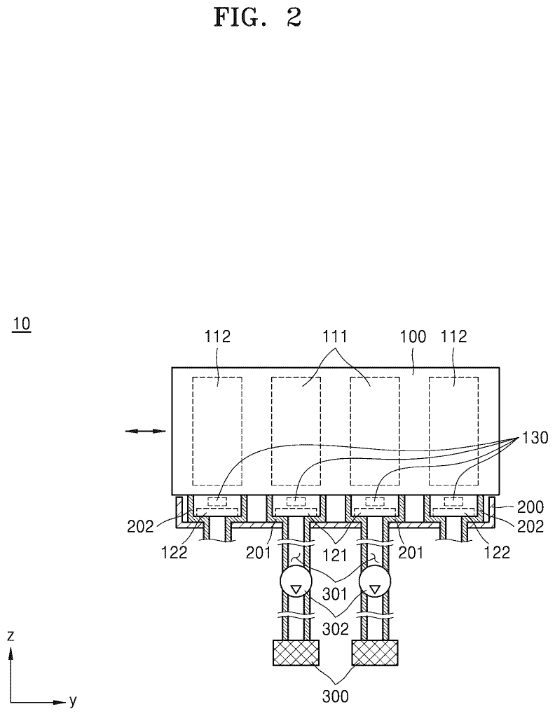

FIG. 1 is a perspective view illustrating an inkjet printing apparatus 10 according to an embodiment, and FIG. 2 is a cross-sectional view of the inkjet printing apparatus 10 in FIG. 1. FIG. 2 illustrates a state in which an inkjet print head 100 and a capping unit 200 are coupled to each other.

Referring to FIGS. 1 and 2, the inkjet printing apparatus 10 according to an embodiment may include the inkjet print head 100 and the capping unit 200, and may be configured to print an image onto a print media P by discharging ink droplets on the print media P.

The inkjet print head 100 may be configured to print the image onto the print media P by discharging the ink droplets of fine sizes (e.g., tens of pico-liters) at desired positions on the print media P while moving along a designated path. The print media P may include at least one of paper, a film, or a fiber, but is not limited thereto.

In an embodiment, the print media P may move in a first direction (e.g., an x direction or −x direction in FIG. 1), and the inkjet print head 100 may discharge the ink droplets at fixed positions on the print media P while moving, but a method of discharging the ink droplets by the inkjet print head 100 is not limited thereto.

In another embodiment, the print media P may move in the first direction and arrive at the inkjet print head 100, and the inkjet print head 100 may discharge the ink droplets to the inkjet print head 100 that arrives at the inkjet print head 100 while moving in a second direction (e.g., a y direction or −y direction in FIG. 1) crossing the first direction. In another embodiment, the inkjet print head 100, while moving in the second direction, may also discharge the ink droplets onto the print media P moving in the first direction.

According to an embodiment, the inkjet print head 100 may include a first cartridge 111, a second cartridge 112, a first print head nozzle 121, a second print head nozzle 122, and a piezoelectric element 130.

Ink droplets may be stored in the first cartridge 111, and unlike in the first cartridge 111, moisturizing liquid may be stored in the second cartridge 112. For example, at least one of key or black ink, cyan ink, magenta ink, and/or yellow ink may be stored in the first cartridge 111, but the embodiment is not limited thereto. In addition, although the drawing only illustrates an embodiment in which the number of the first cartridge 111 is two, but the number of the first cartridge 111 is not limited thereto.

In the related art, the inkjet print head usually only includes a cartridge in which ink droplets are stored. However, the inkjet print head 100 according to an embodiment, which includes the first cartridge 111 storing the ink droplets and the second cartridge 112 storing the moisturizing liquid, may store both of the ink droplets and the moisturizing liquid.

The first print head nozzle 121 may be arranged to be fluidly connected to or fluidly communicated with an inner portion of the first cartridge 111, and may serve to discharge the ink stored in the first cartridge 111 onto the print media P. For example, the first print head nozzle 121 may be at a bottom of the inkjet print head 100 and may be fluidly connected to the first cartridge 111 through an ink supply path (not shown), but a position to arrange the first print head nozzle 121 and a type of connection between the first print head nozzle 121 and the first cartridge 111 are not limited thereto.

The second print head nozzle 122 may be arranged to be fluidly connected to or fluidly communicated with an inner portion of the second cartridge 112, and may serve to discharge the moisturizing liquid stored in the second cartridge 112 toward the capping unit 200. For example, the second print head nozzle 122 may be in an area adjacent to the first print head nozzle 121 at the bottom of the inkjet print head 100 and be fluidly connected to the second cartridge 112 through a moisturizing liquid supply path (not shown), but a position to arrange the second print head nozzle 122 and a type of connection between the second print head nozzle 122 and the second cartridge 112 are not limited thereto.

The piezoelectric element 130 may be configured to provide a driving force for the ink stored in the first cartridge 111 and/or the moisturizing liquid stored in the second cartridge 112 to be discharged outside the inkjet print head 100 through the first print head nozzle 121 and/or the second print head nozzle 122. For example, the piezoelectric element 130 may include a first piezoelectric element, which is configured to provide a driving force for the ink droplets to be discharged outside the inkjet print head 100 through the first print head nozzle 121, and a second piezoelectric element configured to provide a driving force for the moisturizing liquid to be discharged outside the inkjet print head 100 through the second print head nozzle 122.

The piezoelectric element 130 may be physically deformed in accordance with supply of an electrical signal strength. For example, the piezoelectric element 130 may be physically transformed while stretching, contracting, or expanding in response to electrical signals, but is not limited thereto.

Due to the physical deformation of the piezoelectric element 130, a pressure may be applied to the ink supply path and/or the moisturizing liquid supply path, and as a result thereof, the ink and/or the moisturizing liquid may be discharged outside the inkjet print head 100 through the first print head nozzle 121 and/or the second print head nozzle 122. For example, when the pressure is applied to the ink supply path due to the physical deformation of the piezoelectric element 130, the ink in the ink supply path may be discharged outside the inkjet print head 100 through the first print head nozzle 121. In another example, when the pressure is applied to the moisturizing liquid supply path due to the physical deformation of the piezoelectric element 130, the moisturizing liquid in the moisturizing liquid supply path may be discharged outside the inkjet print head 100 through the second print head nozzle 122.

The capping unit 200 may be detachably coupled to the inkjet print head 100, and may serve to protect the inkjet print head 100 when coupled to the inkjet print head 100. More particularly, the capping unit 200 may include a first cap 201 for protecting the first print head nozzle 121 and a second cap 202 for protecting the second print head nozzle 122 when the capping unit 200 is coupled to the inkjet print head 100. Although only two first caps 201 at a center of the capping unit 200 and two second caps 202 at two ends of the capping unit 200 are shown in the drawings, relative arrangements and the numbers of the first cap 201 and the second cap 202 are not limited thereto.

For example, the first cap 201 may be detachably coupled to an area of the inkjet print head 100, in which the first print head nozzle 121 is arranged, and may protect the first print head nozzle 121 and/or the second print head nozzle 122 from external impact or introduction of foreign materials. The second cap 202 may be detachably coupled to an area in which the second print head nozzle 122 is arranged, and may protect the second print head nozzle 122 from external impact or introduction of foreign materials.

According to an embodiment, the capping unit 200 may be coupled to/detached from the inkjet print head 100 while moving in the z direction or the −z direction through a driving unit (not shown). For example, the driving unit may include a cam being in contact with at least an area of the capping unit 200, and the capping unit 200 may move in the z direction or the −z direction in correspondence to rotation of the cam, but a type of the driving unit is not limited thereto.

For example, as the capping unit 200 moves in the −z direction away from the inkjet print head 100, the capping unit 200 may be detached from the inkjet print head 100. On the other hand, as the capping unit 200 moves in the z direction in a state of being detached from the inkjet print head 100, the capping unit 200 may be coupled to the inkjet print head 100.

In the inkjet printing apparatus 10 according to an embodiment, through the driving unit, the capping unit 200 may be detached from the inkjet print head 100 while the inkjet print head 100 operates or discharges the moisturizing liquid, and while the inkjet print head 100 does not operate or moisturizes the first cap 201, the inkjet print head 100 and the capping unit 200 may be coupled to each other to protect the first print head nozzle 121.

Some of the ink droplets may be solidified in a process of discharging the ink droplets through the first print head nozzle 121, and the solidified ink droplets may degrade jet performance of the first print head nozzle 121. For example, when the solidified ink droplets block the first print head nozzle 121, ink jetting performance of the first print head nozzle 121 may be degraded, causing general degradation in printing performance of the inkjet printing apparatus 10.

As the inkjet print head 100 moves, the second print head nozzle 122 and the first cap 201 may be respectively arranged at positions corresponding to each other, and in this state, the second print head nozzle 122 may discharge the moisturizing liquid to the first cap 201. For example, in a state where the second print head nozzle 122 and the first cap 201 are arranged at the positions facing each other, as the second print head nozzle 122 discharges the moisturizing liquid to the outside of the inkjet print head 100, the first cap 201 may hold the moisturizing liquid. However, a method in which the moisturizing liquid is stored in the first cap 201 is not limited thereto.

Thereafter, as the inkjet print head 100 moves, the first print head nozzle 121 and the first cap 201 may be arranged at the positions corresponding to each other. In the aforementioned state, when the capping unit 200 moves in the z direction, the capping unit 200 may be coupled to the inkjet print head 100, and accordingly, the first print head nozzle 121 may be moisturized by the moisturizing liquid held in the first cap 201. For example, in a state where the first print head nozzle 121 and the first cap 201 are arranged at positions facing each other, as the capping unit 200 and the inkjet print head 100 are coupled to each other, the first print head nozzle 121 may maintain moisture due to the moisturizing liquid stored in the first cap 201.

The inkjet printing apparatus 10 according to an embodiment may maintain the performance of the inkjet printing apparatus 10 by discharging the moisturizing liquid to the first cap 201 to prevent the first print head nozzle 121 from being dry or blocked. For example, the inkjet printing apparatus 10 may maintain the moisture of the first print head nozzle 121 by moving the inkjet print head 100 in the y direction or the −y direction and moving the capping unit 200 in the z direction or the −z direction.

According to an embodiment, the first cap 201 may be connected to or communicated with an ink waste storage tank 300, in which an ink waste is stored, through an ink discard path 301. In the disclosure, the ink waste may indicate a mixture of solidified ink droplets separated from print head nozzles, a contaminated moisturizing liquid, and/or foreign materials (e.g., dust). For example, when the moisturizing of the first print head nozzle 121 ends, the ink waste, that is, the solidified ink droplets and the foreign materials separated from the first print head nozzle 121, may remain in the first cap 201 in a state of being mixed with the moisturizing liquid in the first cap 201.

A pump 302 for passing the ink waste remaining in the first cap 201 to the ink waste storage tank 300 may be arranged in the ink discard path 301. For example, when the moisturizing of the first print head nozzle 121 ends, the ink waste may remain in the first cap 201. The pump 302 may be arranged in the ink discard path 301 and provide power to pass the ink waste flow in a direction toward the ink waste storage tank 300.

The inkjet printing apparatus 10 according to an embodiment may discharge the ink waste remaining in the first cap 201 to the ink waste storage tank 300 through the ink discard path 301, thereby preventing damage to internal components of the inkjet printing apparatus 10 due to the ink waste and increase life of the inkjet printing apparatus 10.

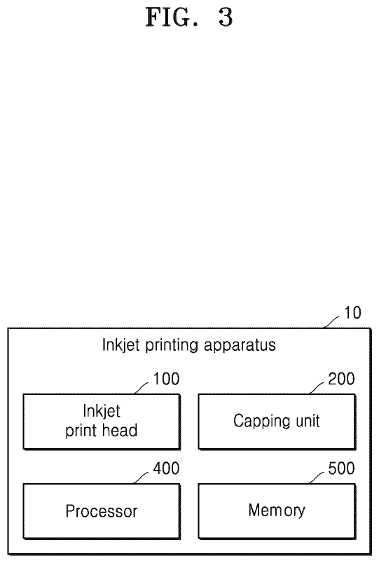

Hereinafter, a process of moisturizing the first print head nozzle 121 of the inkjet printing apparatus 10 will be described in detail with reference to FIGS. 3 to 9.

FIG. 3 is a block diagram illustrating components of the inkjet printing apparatus 10 according to an embodiment.

Referring to FIG. 3, the inkjet printing apparatus 10 according to an embodiment may include the inkjet print head 100 (e.g.: the inkjet print head 100 in FIGS. 1 and 2), the capping unit 200 (e.g., the capping unit 200 in FIGS. 1 and 2), a processor 400, and a memory 500. The components of the inkjet printing apparatus 10 are not limited to the components illustrated in the drawings, and according to embodiments, any one component (e.g.: the pump 302 in FIGS. 1 and 2) may be added, or any one component (e.g.: the memory 500) may be omitted. The components of the inkjet printing apparatus 10 may be identical or similar to at least one of the components of the inkjet printing apparatus 10 in FIG. 1 and/or FIG. 2, and hereinafter, same descriptions will not be repeatedly given.

The processor 400 may be configured to control general operations of the inkjet printing apparatus 10. For example, the processor 400 may be electrically or operatively connected to the driving unit that is configured to cause the inkjet print head 100 and/or the capping unit 200 to move, and may be configured to control operation of the inkjet print head 100 and/or movement of the capping unit 200. In the disclosure, the expression “operatively connected” may indicate a state where components are connected to each other to exchange signals through wireless communication or exchange optical signals and/or magnetic signals, and the expression may be used as the same meaning hereinafter.

In an embodiment, the processor 400 may cause the inkjet print head 100 to move to another position, or may jet the ink droplets and/or the moisturizing liquid outside the inkjet print head 100 through the first print head nozzle 121 and/or the second print head nozzle 122. For example, the processor 400 may cause the inkjet print head 100 to move to another position such that the first print head nozzle 121 is arranged at the position corresponding to the position of the print media (e.g.: the print media P in FIG. 1 or FIG. 2) and then cause the inkjet print head 100 to discharge or jet the ink droplets to a designated position of the print media through the first print head nozzle 121. In addition, the processor 400 may cause the inkjet print head 100 to move to another position such that the second print head nozzle 122 is arranged at a position corresponding to a position of the second cap 202 (e.g.: the second cap 202 in FIGS. 1 and 2), and then cause the inkjet print head 100 to discharge or jet the moisturizing liquid through the second print head nozzle 122. In addition, the processor 400 may also cause the inkjet print head 100 to move to another position such that the second print head nozzle 122 is arranged at the position corresponding to the position of the first cap (e.g., the first cap 201 in FIGS. 1 and 2).

According to an embodiment, the processor 400 may be configured to control the operation of the inkjet print head 100 based on data stored in the memory 500. For example, data regarding correlation between a temperature of the moisturizing liquid and a viscosity of the moisturizing liquid may be stored in the memory 500. Even when a same electrical signal strength is applied to a piezoelectric element (e.g., the piezoelectric element 130 in FIG. 2), an amount of the moisturizing liquid jetted through the second print head nozzle 122 may vary according to the viscosity of the moisturizing liquid. Accordingly, the processor 400 may constantly maintain the amount of the moisturizing liquid jetted through the second print head nozzle 122 by adjusting the electrical signal strength applied to the piezoelectric element based on the data stored in the memory 500, i.e., the data regarding the correlation between the temperature of the moisturizing liquid and the viscosity of the moisturizing liquid. However, detailed descriptions regarding operation of the processor 400 to adjust the electrical signal strength applied to the piezoelectric element according to the viscosity of the moisturizing liquid will be given later.

In another example, the processor 400 may cause the capping unit to move to become detached from the inkjet print head 100 or become coupled to the inkjet print head 100. For example, the processor 400 may have the capping unit 200 detached from the inkjet print head 100 before jetting the moisturizing liquid to the second cap 202, but control operation of the processor 400 is not limited thereto. For another example, the processor 400 may have the capping unit 200 coupled to the inkjet print head 100 to provide moisture to the first print head nozzle 121, but the control operation of the processor 400 is not limited thereto.

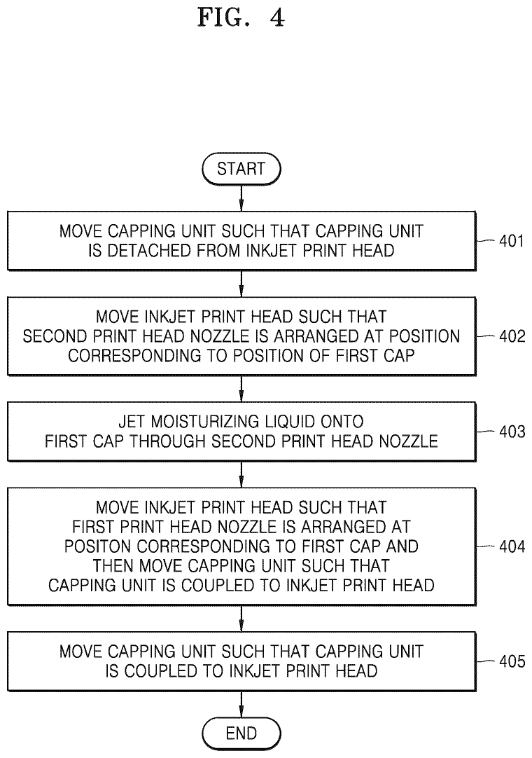

Hereinafter, a process of moisturizing the first print head nozzle 121 by the processor 400 through the inkjet print head 100 and the driving unit will be described in detail with reference to FIGS. 4 to 9.

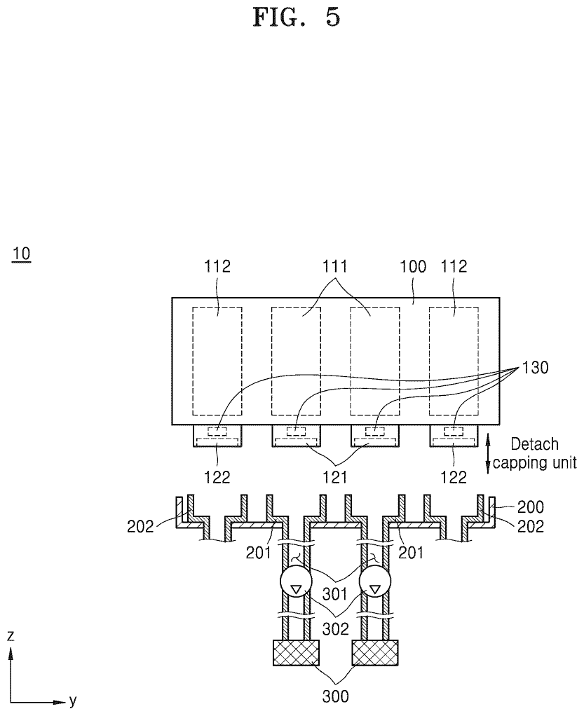

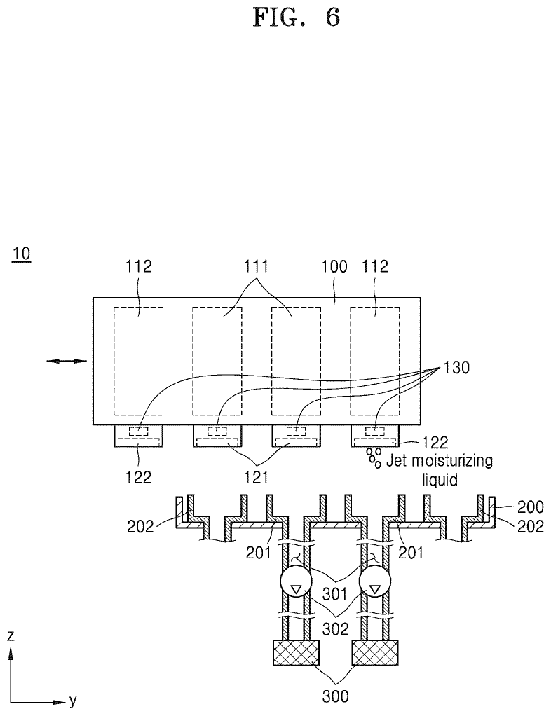

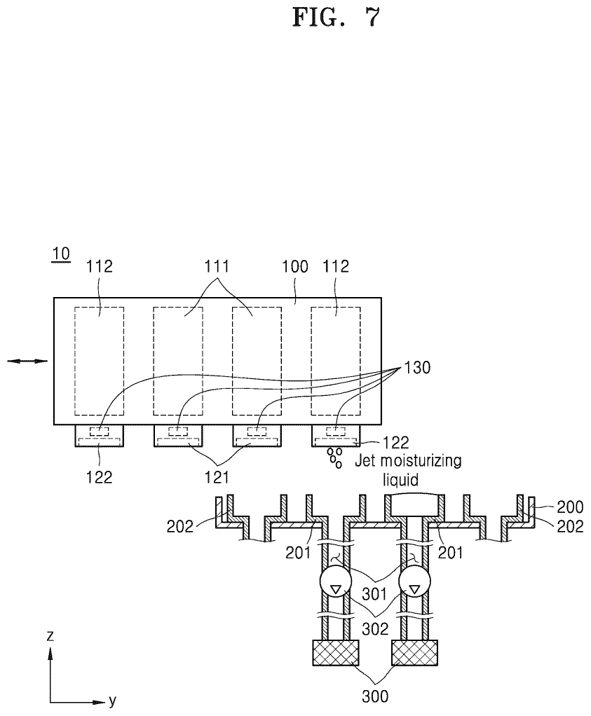

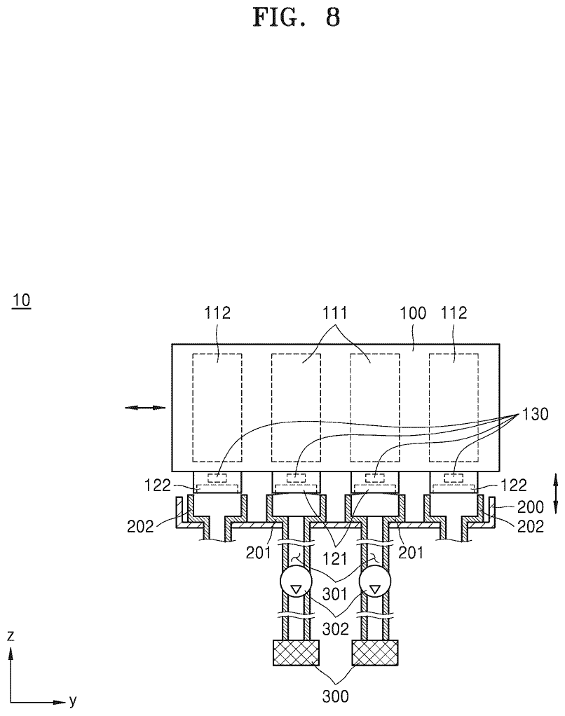

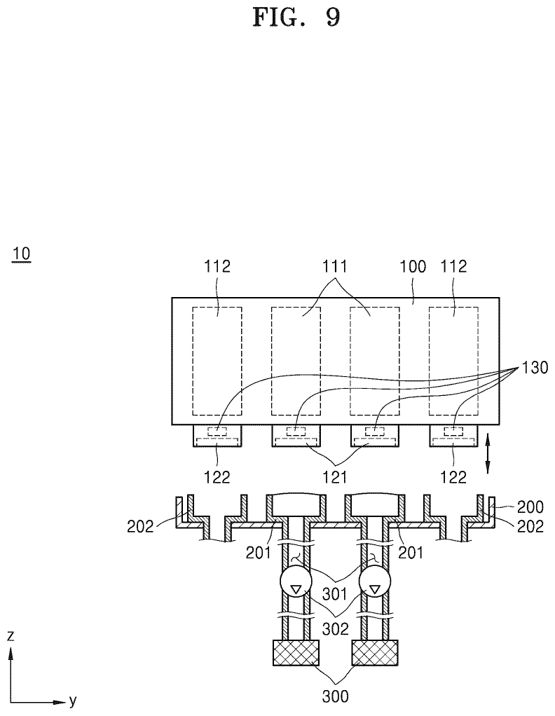

FIG. 4 is a flowchart for describing operations to moisturize the print head nozzles of the inkjet printing apparatus 10 according to an embodiment. In addition, FIG. 5 is a diagram for describing a process of having the capping unit 200 of the inkjet printing apparatus 10 according to an embodiment from the inkjet print head 100, FIG. 6 is a diagram for describing a process of jetting the moisturizing liquid to the first cap 201 after moving the inkjet print head 100 of the inkjet printing apparatus 10 in FIG. 5, and FIG. 7 is a diagram for describing a process of jetting the moisturizing liquid to another first cap 201 after moving the inkjet print head 100 of the inkjet printing apparatus 10 in FIG. 6. In addition, FIG. 8 is a diagram for describing a process of having the capping unit 200 coupled to the inkjet print head 100 after moving the inkjet print head 100 of the inkjet printing apparatus 10 in FIG. 7, and FIG. 9 is a diagram for describing a process of discharging residue remaining in the first cap 201 after having the capping unit 200 of the inkjet printing apparatus 10 in FIG. 8 detached from the inkjet print head 100. Hereinafter, descriptions of the operations in FIG. 4 to provide the moisture to the print head nozzles of the inkjet printing apparatus 10 will be given with reference to the components illustrated in FIGS. 5 to 9.

Referring to FIG. 4, in operation 401, the inkjet printing apparatus 10 according to an embodiment may cause the capping unit 200 to move in a state where the inkjet print head 100 and the capping unit 200 are coupled to each other, to thereby cause the capping unit 200 to be detached from the inkjet print head 100.

For example, the processor (e.g., the processor 400 in FIG. 3) of the inkjet printing apparatus 10 may cause the capping unit 200 to move in the −z direction away from the inkjet print head 100 through the driving unit, as illustrated in FIG. 5, and as a result thereof, the capping unit 200 may be detached from the inkjet print head 100.

In operation 402, the inkjet printing apparatus 10 according to an embodiment, after having the capping unit 200 detached from the inkjet print head 100 through operation 402, may cause the inkjet print head 100 to move such that the second print head nozzle 122 is arranged at the position corresponding to the position of the first cap 201. For example, the processor of the inkjet printing apparatus 10 may cause the inkjet print head 100 to move such that the second print head nozzle 122 is located on top of the first cap 201, as illustrated in FIG. 6.

In the disclosure, the expression “the second print head nozzle 122 is arranged at the position corresponding to the position of the first cap 201” may indicate that the second print head nozzle 122 is on the top of the first cap 201 and thus the second print head nozzle 122 and the first cap 201 are arranged to overlap each other when seen from the z direction, and the expression may be used as the same meaning hereinafter.

In operation 403, the inkjet printing apparatus 10 according to an embodiment, after causing the inkjet print head 100 to move such that the second print head nozzle 122 is arranged at the position corresponding to the position of the first cap 201 through operation 402, may cause the inkjet print head 100 to the moisturizing liquid to the first cap 201 through the second print head nozzle 122. For example, the processor of the inkjet printing apparatus 10 may apply the electrical signal strength to the piezoelectric element 130 such that the moisturizing liquid is jetted from the second print head nozzle 122.

For example, as illustrated in FIGS. 6 and 7, when the inkjet printing apparatus 10 includes a plurality of the first print head nozzles 121 and a plurality of the first caps 201, the processor of the inkjet printing apparatus 10 may cause the inkjet printing apparatus 10 to move such that the second print head nozzle 122 is arranged at the position corresponding to each of the plurality of first caps 201, thereby causing the inkjet print head 100 to jet the moisturizing liquid to each of the first caps 201 through the second print head nozzle 122. As a result, the moisturizing liquid may be stored in each of the plurality of first caps 201.

In operation 404, the inkjet printing apparatus 10 according to an embodiment, after causing the inkjet printing apparatus 10 to move such that the first print head nozzle 121 is arranged at the position corresponding to the position of the first cap 201, may cause the capping unit 200 to move such that the capping unit 200 is coupled to the inkjet print head 100.

For example, the processor of the inkjet printing apparatus 10 may cause the inkjet print head 100 to move such that the first print head nozzle 121 is located on the top of the first cap 201. In other words, the processor of the inkjet printing apparatus 10 may cause the inkjet print head 100 to move such that the first print head nozzle 121 and the first cap 201 are arranged to overlap each other when the first print head nozzle 121 and the first cap 201 are seen from the z direction. Thereafter, as illustrated in FIG. 8, as the processor of the inkjet printing apparatus 10 causes the capping unit 200 to move in the z direction being closer to the inkjet print head 100 through the driving unit, the capping unit 200 may be coupled to the inkjet print head 100.

As a result, at least a portion of the first print head nozzle 121 may be in contact with the moisturizing liquid held by the first cap 201, and the solidified ink droplets deposited on the first print head nozzle 121 and/or foreign materials (e.g., dust and the like) may be removed from the first print head nozzle 121 by the moisturizing liquid. The inkjet printing apparatus 10 according to an embodiment may provide sufficient moisture to the first print head nozzle 121 through operation 404, thereby preventing the first print head nozzle 121 from being dry or blocked.

In operation 405, the inkjet printing apparatus 10 according to an embodiment may cause the capping unit 200 to move to become detached again from the inkjet print head 100. Here, a time point at which the capping unit 200 is detached again from the inkjet print head 100 may be determined (or modified) based on a preset time period or a user input stored in a memory (e.g., the memory 500 in FIG. 3).

For example, after the preset time period from a time point at which the capping unit 200 and the inkjet print head 100 are coupled to each other, the processor of the inkjet printing apparatus 10 may cause the capping unit 200 to be detached from the inkjet print head 100 by causing the capping unit 200 to move in the −z direction away from the inkjet print head 100, as illustrated in FIG. 8.

In the disclosure, the preset time period may indicate a preset time period in which the capping unit 200 is coupled to the inkjet print head 100 and moisturizing is performed on the first print head nozzle 121 by using the moisturizing liquid held in the first cap 201.

For another example, when a user input is received in the state where the capping unit 200 and the inkjet print head 100 are coupled to each other, the processor of the inkjet printing apparatus 10 may cause the capping unit 200 to be detached from the inkjet print head 100 by causing the capping unit 200 to move in the −z direction away from the inkjet print head 100, as illustrated in FIG. 8.

In the disclosure, the user input may indicate an input to the inkjet printing apparatus 10 by a user who attempts to finish moisturizing of the first print head nozzle 121. For example, the user may input a signal to request to finish moisturizing the first print head nozzle 121 through a user interface (e.g., a button, a display, and the like) provided in the inkjet printing apparatus 10. The processor of the inkjet printing apparatus 10, which receives the signal, may cause the capping unit 200 to away from the inkjet print head 100 to become detached from the inkjet print head 100.

Alternatively, as the user inputs a signal indicating that an image is printed by using the inkjet printing apparatus 10, the processor of the inkjet printing apparatus 10 may finish moisturizing the first print head nozzle 121 by causing the capping unit 200 to move away from the inkjet print head 100 and be detached from the inkjet print head 100.

According to an embodiment, by repeatedly performing the aforementioned operation 401 to operation 405 according to the designated cycle, the inkjet printing apparatus 10 may maintain the moisture of the first print head nozzle 121 despite repeated use of the inkjet printing apparatus 10.

Additional units were generally provided in inkjet printing apparatus in the related art to remove solidified ink droplets and/or foreign materials deposited on the first print head nozzle 121, and due to the additional units, and the entire size of the inkjet printing apparatuses inevitably increased.

On the other hand, the inkjet printing apparatus 10 according to an embodiment may maintain the moisture of the first print head nozzle 121 without the additional units by providing moisture through the inkjet print head 100 that already exists, and as a result thereof, the performance of the first print head nozzle 121 may be maintained while promoting downsizing of the inkjet printing apparatus 10.

In addition, in inkjet printing apparatuses in the related art, a large amount of moisturizing liquid used to be wasted. However, the inkjet printing apparatus 10 may jet the moisturizing liquid onto the first cap 201 through the second print head nozzle 122, and thus may efficiently remove the solidified ink droplets deposited on the first print head nozzle 121 even with a relatively large amount of jet liquid.

According to another embodiment, the inkjet printing apparatus 10 may also perform operation 401 to operation 405 described above, based on the amount of the solidified ink droplets deposited on the first print head nozzle 121. For example, the inkjet printing apparatus 10 may further include an observation device (e.g., a camera) configured to obtain image data regarding the first print head nozzle 121, and the processor may be configured to estimate the amount of the solidified ink droplets deposited on the first print head nozzle 121, based on the image data obtained through the observation device.

When the estimated amount of the solidified ink droplets is equal to or greater than a pre-designated amount, the processor may determine that the jet performance of the first print head nozzle 121 may be degraded and then provide moisture to the first print head nozzle 121 by performing operation 401 to operation 405 described above. That is, the inkjet printing apparatus 10 according to the other embodiment may maintain the jet performance and the moisture of the first print head nozzle 121 while minimizing power consumption by performing operation 401 to operation 405 only when the amount of the solidified droplets deposited on the first print head nozzle 121 is equal to or greater than a preset amount.

Although not shown, when moisturizing the first print head nozzle 121 ends, the inkjet printing apparatus 10 according to an embodiment may discharge an ink waste remaining in the first cap 201 to the ink waste storage tank 300 through the ink discard path 301. For example, when the capping unit 200 is detached from the inkjet print head 100 through operation 405, the processor of the inkjet printing apparatus 10 may provide power to the pump 302 arranged in the ink discard path 301, to thereby cause the ink waste remaining in the first cap 201 move to the ink waste storage tank 300.

The inkjet printing apparatus 10 according to an embodiment may discharge the ink waste remaining in the first cap 201 to the ink waste storage tank 300 through the ink discard path 301, thereby preventing damage to internal components of the inkjet printing apparatus 10 due to the ink waste and increase life of the inkjet printing apparatus 10.

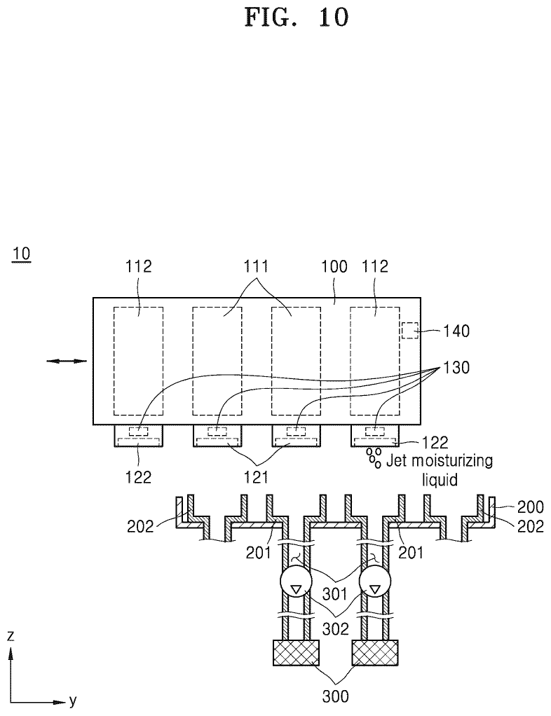

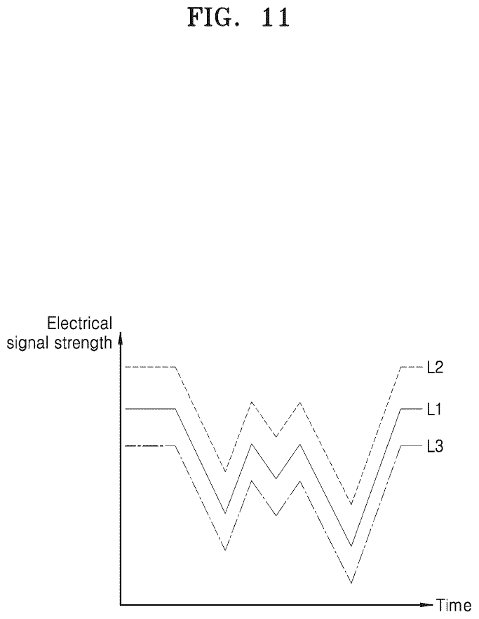

FIG. 10 is a cross-sectional view of the inkjet printing apparatus 10 according to another embodiment, and FIG. 11 is a graph for describing change in an electrical signal strength applied to the piezoelectric element 130 in the inkjet printing apparatus 10 in FIG. 10.

Referring to FIGS. 10 and 11, the inkjet printing apparatus 10 according to the other embodiment may include the inkjet print head 100 and the capping unit 200, wherein the inkjet print head 100 includes the first cartridge 111, the second cartridge 112, the first print head nozzle 121, the second print head nozzle 122, the piezoelectric element 130, and a sensor 140, and the capping unit 200 includes the first cap 201 and the second cap 202. The inkjet printing apparatus 10 according to the other embodiment may include an apparatus in which the sensor 140 is added to the inkjet printing apparatus 10 in FIG. 1 or FIG. 2, and same descriptions will not be repeatedly given hereinafter.

The sensor 140 may be arranged adjacent to the second cartridge 112 and obtain data regarding the moisturizing liquid stored in the second cartridge 112. For example, the sensor 140 may include a temperature sensor, and may obtain data regarding the temperature of the moisturizing liquid stored in the second cartridge 112.

A processor (e.g., the processor 400 in FIG. 3) may be configured to adjust the electrical signal strength applied to the piezoelectric element 130 such that a constant amount of the moisturizing liquid may be jetted onto the first cap 201, based on the data regarding the temperature of the moisturizing liquid obtained through the sensor 140. As the temperature of the moisturizing liquid changes, the viscosity of the moisturizing liquid may also change. For example, the lower the temperature of the moisturizing liquid, the higher the viscosity of the moisturizing liquid may be. Accordingly, even when a same electrical signal strength is applied to the second piezoelectric element configured to provide the driving force to the second print head nozzle 122, an amount of the moisturizing liquid jetted through the second print head nozzle 122 may vary according to the temperature of the moisturizing liquid.

For example, when a first electrical signal strength L1 is applied to the second piezoelectric element and the temperature of the moisturizing liquid is a first temperature, a first amount of the moisturizing liquid may be sprayed through the second print head nozzle 122. On the other hand, when the first electrical signal strength L1 is applied to the second piezoelectric element and the temperature of the moisturizing liquid is a second temperature lower than the first temperature, as the viscosity of the moisturizing liquid increases, a second amount of the moisturizing liquid may be sprayed through the second print head nozzle 122, here, the second amount is less than the first amount.

According to an embodiment, the processor may be configured to compare the temperature of the moisturizing liquid through the sensor 140 with the data stored in the memory, i.e., the data regarding the correlation between the temperature of the moisturizing liquid and the viscosity of the moisturizing liquid, and adjust an electrical signal strength applied to the second piezoelectric element, such that a constant amount of the moisturizing liquid is sprayed from the second print head nozzle 122.

For example, as illustrated in FIG. 11, the processor may apply the first electrical signal strength L1 to the second piezoelectric element when the temperature of the moisturizing liquid is the first temperature, and may apply a second electrical signal strength L2 having a greater magnitude than a magnitude of the first electrical signal strength L1 when the temperature of the moisturizing liquid is the second temperature lower than the first temperature.

As another example, when the temperature of the moisturizing liquid is a third temperature higher than the first temperature, the processor may apply, to the second piezoelectric element, a third electrical signal strength L3 having a less magnitude than the magnitude of the first electrical signal strength L1.

Through the operation of the processor, the inkjet printing apparatus 10 according to another embodiment may jet a constant amount of the moisturizing liquid onto the first cap 201, regardless of the temperature of the moisturizing liquid.

According to another embodiment, the processor may also be configured to adjust an electrical signal strength applied to the second piezoelectric element, in consideration of change in the jet performance of the second print head nozzle 122, as well as the temperature of the moisturizing liquid obtained through the sensor 140. For example, when it is determined that the jet performance of the second print head nozzle 122 is degraded during use of the inkjet printing apparatus 10, the processor may include an electrical signal strength having a magnitude greater than the magnitudes of the existing signals, such that a constant amount of the moisturizing liquid may be sprayed despite the degradation in the jet performance of the second print head nozzle 122, but the embodiment is not limited thereto.

The method according to the embodiments may also be implemented in the form of a recording media including computer-executable instructions, e.g., a program module executed by a computer. A computer-readable media may include any available media that may be accessed by a computer and includes all of volatile media, nonvolatile media, removable media, and non-removable media. In addition, the computer-readable media may include a computer storage media and a communication media. The computer storage media includes both volatile and nonvolatile, and removable and non-removable media implemented in any method or technology for storage of information such as computer readable instructions, data structures, program modules or other data. The communication media may include computer-readable instructions, data structures, and other data in non-transitory data signals, such as program modules.

It will be understood to one of ordinary skill in the art related to the embodiments that the embodiments may be implemented in a modified form without departing from the scope of the disclosure. Therefore, the embodiments of the disclosure should be considered as illustrative examples only, and should not be construed as limiting the scope of the disclosure. The scope of the disclosure is described in the claims rather than the foregoing description, and any modifications, substitutions and improvements of the embodiments of the disclosure should be construed as being included in the disclosure.

The inkjet printing apparatus according to various embodiment may be configured to precisely adjust locations to jet the moisturizing liquid and the amount of moisturizing liquid being sprayed through the method of jetting the moisturizing liquid onto the caps through the inkjet print head, and as a result thereof, may efficiently protect the print head nozzles from being dried or blocked.

Advantageous effects obtained by the embodiments are not limited to the aforementioned embodiments, and other unmentioned effects may be clearly understood to one of ordinary skill in the art based on the present specification and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An inkjet printing apparatus comprising:
an inkjet printing head movable in a designated direction and comprising a first print head nozzle configured to jet ink droplets and a second print head nozzle configured to jet a moisturizing liquid;
a capping unit detachably coupled to the inkjet printing head and comprising a first cap protecting the first print head nozzle and a second cap protecting the second nozzle when the capping unit is coupled to the inkjet print head; and
a processor operatively connected to the inkjet print head and the capping unit and configured to cause the inkjet print head to jet the moisturizing liquid on the first cap.

2. The inkjet printing apparatus of claim 1, wherein the processor is further configured to:
in response to the inkjet print head and the accommodating unit being coupled to each other, cause the capping unit to move and become detached from the inkjet print head,
in response to the capping unit being detached from the inkjet print head, cause the inkjet print head to move such that the second print head nozzle is arranged at a position corresponding to a position of the first cap, and
cause the inkjet print head to jet the moisturizing liquid on the first cap through the second print head nozzle.

3. The inkjet printing apparatus of claim 2, wherein the processor is further configured to:
after the moisturizing liquid is sprayed onto the first cap through the second print head nozzle, cause the inkjet print head to move such that the first print head nozzle is arranged at a position corresponding to the position of the first cap, and
cause the capping unit to move in a direction toward the inkjet print head and become coupled again to the inkjet print head.

4. The inkjet printing apparatus of claim 3, wherein the processor is further
after a preset time period from a time point at which the cap accommodating and the inkjet print head are coupled to each other, cause the capping unit to move to become detached again from the inkjet print head.

5. The inkjet printing apparatus of claim 3, wherein the processor is further configured to:
in response to a user input being received after the capping unit and the inkjet print head are coupled to each other, cause the capping unit to move to become detached again from the inkjet print head.

6. The inkjet printing apparatus of claim 4, further comprising
an ink waste storage tank in which ink waste is stored;
an ink discard path connecting the capping unit to the ink waste storage tank; and
a pump located in the ink discard path and configured to provide power to the ink waste remaining in the first cap to move in a direction toward the ink waste storage tank.

7. The inkjet printing apparatus of claim 6, wherein the processor is further configured to:
in response to the capping unit being detached from the inkjet print head, provide electrical power to the pump and to discharge the ink waste to the ink waste storage tank.

8. The inkjet printing apparatus of claim 2, wherein the processor is further configured to:
adjust an amount of jet of the moisturizing liquid sprayed through the second print head nozzle.

9. The inkjet printing apparatus of claim 8, wherein the inkjet print head further comprises:
a first piezoelectric element configured to discharge the ink droplets outside the inkjet print head through the first print head nozzle;
a second piezoelectric element configured to discharge the moisturizing liquid outside the inkjet print head through the second print head nozzle; and
a sensor configured to detect a temperature of the moisturizing liquid.

10. The inkjet printing apparatus of claim 9, wherein the processor is further configured to:
adjust an electrical signal strength applied to the second piezoelectric element based on the temperature of the moisturizing liquid detected through the sensor such that a constant amount of the moisturizing liquid is sprayed onto the first cap.

11. The inkjet printing apparatus of claim 9, further comprising memory storing data regarding a correlation between the temperature of the moisturizing liquid and viscosity of the moisturizing liquid,
wherein the processor is further configured to:
adjust an electrical signal strength applied to the second piezoelectric element based on the data stored in the memory, wherein the data is about the correlation between the temperature of the moisturizing liquid and the viscosity of the moisturizing liquid.

12. The inkjet printing apparatus of claim 5, further comprising
an ink waste storage tank in which ink waste is stored;
an ink discard path connecting the capping unit to the ink waste storage tank; and
a pump located in the ink discard path and configured to provide power to the ink waste remaining in the first cap to move in a direction toward the ink waste storage tank.

13. The inkjet printing apparatus of claim 12, wherein the processor is further configured to:
in response to the capping unit being detached from the inkjet print head, provide electrical power to the pump and to discharge the ink waste to the ink waste storage tank.
